(19) United States
(12) Patent Application Publication
(10) Pub. No.: US 2011/0244123 A1
(43) Pub. Date: Oct. 6, 2011

(54) OXIDE COATED CERAMIC POWDERS

(75) Inventors: Richard D. Weir, Cedar Park, TX (US); Lucas Pettey, Austin, TX (US)

(73) Assignee: EEStor, Inc., Cedar Park, TX (US)

(21) Appl. No.: 13/039,165

(22) Filed: Mar. 2, 2011

Related U.S. Application Data
(60) Provisional application No. 61/309,583, filed on Mar. 2, 2010.

(51) Int. Cl. B05D 3/02

(52) U.S. Cl. 427/215

(57) ABSTRACT

A method of forming a dielectric powder includes depositing a metal nitrate coating on ceramic particles to form nitrate coated ceramic particles, separating the nitrate coated ceramic particles, dewatering the nitrate coated ceramic particles, and heat treating the nitrate coated ceramic particles at a temperature sufficient to convert the metal nitrate to a metal oxide, forming metal oxide coated ceramic particles.

### CROSS-REFERENCE TO RELATED APPLICATION(S)

The present application claims priority from U.S. Provisional Patent Application No. 61/309,583, filed Mar. 2, 2010, entitled “OXIDE COATED CERAMIC POWDERS,” naming inventor Richard D. Weir, which application is incorporated by reference herein in its entirety.

### FIELD OF THE DISCLOSURE

The present disclosure, in general, relates to ceramic powders and in particular, to oxide coated ceramic powders, such as those useful as dielectric materials.

### BACKGROUND

In conventional methods, powder particulates in a slurry are coated with a solute from a saturated or near-saturated solution. High blade-tip-speed mechanical mixing is employed to keep the powder in suspension while absolute (water-free) or near-absolute alcohol is slowly metered into the slurry so as to maintain as near as possible homogeneity throughout the slurry volume. As a result, such conventional methods utilize a relatively long time for coating deposition, and the potential of uneven coating thickness due to the concentration of the alcohol is much higher at the entry point of the alcohol.

As the alcohol is added, the solute deposits on the powder particulates because the solubility of the solute in aqueous solution has been exceeded. The alcohol is soluble in water. With increasing concentration of alcohol, the concentration of water available for maintaining the solute in solution is reduced. Such an approach is akin to the use of 2-propanol (isopropyl alcohol) to remove water from surfaces, i.e., for drying. Further, such conventional methods rely upon insolubility of the coating material in alcohol.

However, many desirable oxide coatings are soluble in alcohol, rendering such conventional techniques ineffective. Further, such conventional techniques are slow and lead to considerable waste.

As such, an improved coating technique would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary process for coating a ceramic powder.

FIG. 2 includes a flow diagram illustration of an exemplary process for coating a ceramic powder.

The use of the same reference symbols in different drawings indicates similar or identical items.

### DESCRIPTION OF THE PREFERRED EMBODIMENT(S)

A procedure is described for coating ceramic powder particulates in a uniform manner with a given film thickness that is substantially consistent throughout the powder batch. The coating system uses centrifuges for dewatering the powder, heating and cooling ultrasonic units for suspending the particles in the solution while the particles are being coated, a flash drying unit for calcining the powder into Al₂O₃-coated particles, and a cyclone for particle separation and capture. A solvent washing technique is also disclosed that removes the water from the particles before drying and assists in keeping the powder from achieving a hard agglomeration state. Such a technique applies an oxide layer derived from a nitrate compound onto a ceramic powder.

In general, Applicants discovered that an alcohol-based technique cannot be used for coating Al(NO₃)₃ and other metal nitrates onto powders because such nitrate compounds are alcohol-soluble. The present method coats ceramic powder, such as composition-modified barium titanate (CMBT) powders, using water-soluble Al(NO₃)₃ in a saturated aqueous solution. As described below, there are several approaches to performing the coating. For example, three approaches to coating the ceramic powders with aluminum oxide are described below. Each of the three approaches deposits aluminum nitrate onto the particles from a saturated or a supersaturated solution.

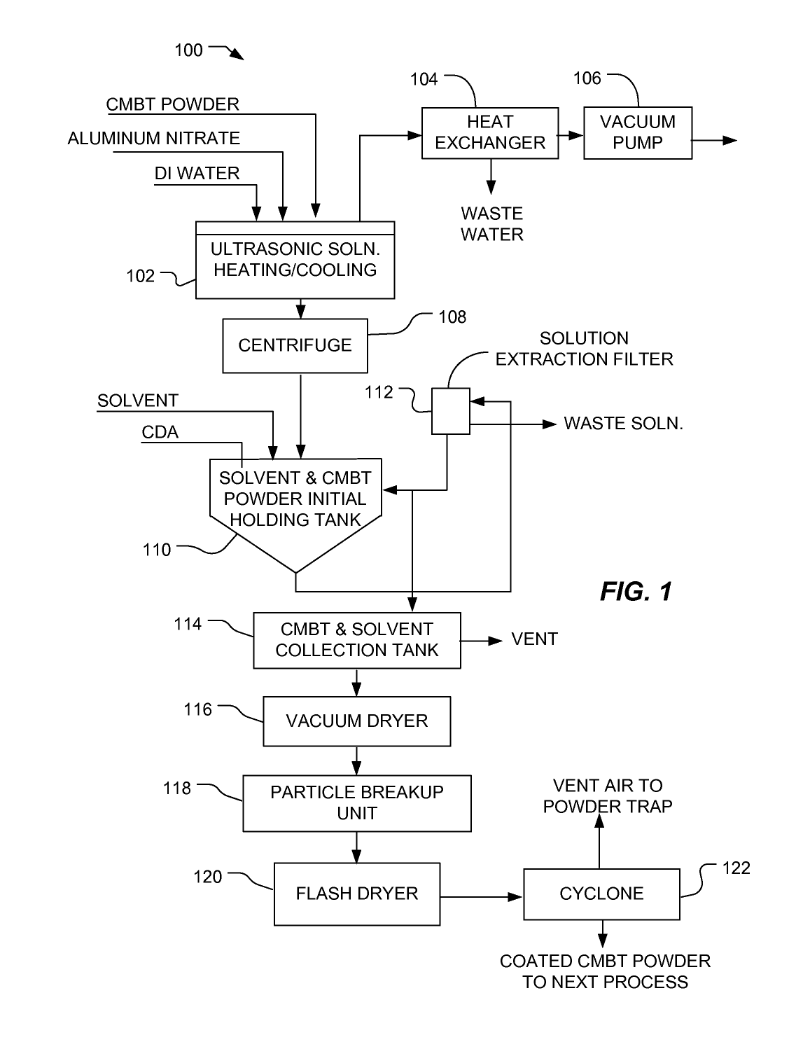

As illustrated in FIG. 1, a system 100 includes a mixing vessel 102. The mixing vessel 102 can be temperature controlled and can include ultrasonic mechanisms. In an example, the ceramic powder, such as a CMBT powder can be added to an aqueous solution including deionized (DI) water and a metal nitrate, such as aluminum nitrate. The solution can be adjusted to achieve metal nitrate saturation or supersaturation, which results in deposition of the metal nitrate on the ceramic powder. In an example, the solution can be heated, placed under vacuum, or a combination thereof to remove water through evaporation, resulting in a saturated metal nitrate solution. For example, the system 100 can include a vacuum pump 106 and a heat exchanger 104 to remove evaporated water before it reaches the vacuum pump 106. In another example, the solution can be saturated by reducing the temperature, changing the solubility of the metal nitrate in the solution. In a further example, the solution can be saturated by first removing water followed by cooling to produce a saturated or supersaturated metal nitrate solution.

Once the metal nitrate coating is applied, the coated powder can be separated from the remaining aqueous solution. For example, the coated ceramic powder can be separated using a centrifuge 108. The separated powder can be transferred to a washing vessel 110. The powder can be washed using a solvent that exhibits low solubility for the metal nitrate. For example, the solvent can be a low molecular weight alcohol, such as ethanol. The solvent can be regenerated, removing water, such as in an extraction filter 112.

Once washed, the coated powder can be forwarded to a collection tank 114. The coated powder can be dried, for example, in a vacuum drier 116, disagglomerated, for example, crushed or milled in a particle breakup unit 118, and heat treated to form a metal oxide from the metal nitrate, such as through a flash dryer 120. To recapture the metal oxide coated powder, a cyclone 122 can be used. Alternatively, a filter can be used.

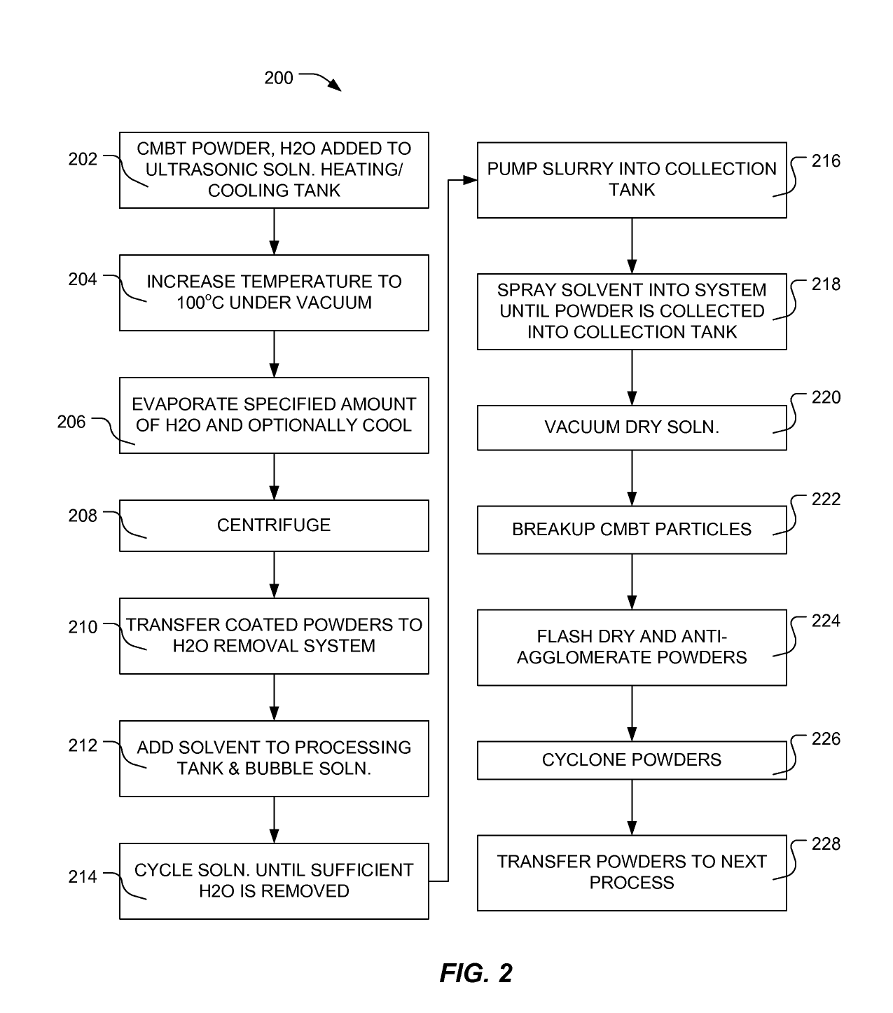

FIG. 2 includes an illustration of an exemplary method 200, which includes providing a ceramic powder, such as CMBT powder, to a vessel including an aqueous solution of metal nitrate, such as aluminum nitrate, as illustrated at 202. For example, the vessel can be maintained near 25° C. In an example, the temperature of the solution is increased to at least within 5° C. of the normal boiling point of the solution at atmospheric pressure, such as to at least the boiling point of the solution or approximately 100° C., as illustrated at 204, to remove water through evaporation. A vacuum (relative to atmospheric pressure) can also be applied to increase the evaporation rate of water. As illustrated at 206, water is evaporated to increase the concentration of the metal nitrate. For example, the concentration can be increased to near saturation, saturation, or supersaturation.

In an alternative example, the solution can be cooled to achieve saturation. Cooling can be performed following evaporation through heating or pressure reduction. In an example, cooling includes cooling by at least 25° C., such as at least 40° C., at least 60° C., or even at least 70° C. Cooling can include cooling to a temperature not greater than 35° C., such as not greater than 30° C., not greater than 28° C., or even not greater than 25° C.

As a result of approaching saturation, metal nitrate is coated over the ceramic particle. In an example, the metal nitrate is aluminum nitrate, such as aluminum nitrate nona-hydrate. The coated particles can be separated from solution, such as using a filtering, centrifuging or a combination thereof. For example, the coated particles can be separated with a centrifuge, such as a cyclone centrifuge, as illustrated at 208, and can be transferred to a wash vessel, as illustrated at 210 to remove water. When saturation is achieved through evaporation and not cooling, the separation equipment can be heated. For example, the separation equipment can be heated to a temperature within at least 20° C. of the evaporation temperature, such as within at least 15° C., or even within at least 10° C. When deposition is achieved through cooling, particularly cooling to a temperature near room temperature, the separation equipment can be not heated, such as maintained near room temperature.

The wash vessel is to dewater or remove water from the coated particles. For example, a non-aqueous solvent, such as an alcohol, a ketone, a glycol, or any combination thereof, can be added to the wash vessel and the solution bubbled, as illustrated at 212, to remove water. In an example, the non-aqueous solvent includes an alcohol that has a normal boiling point not greater than the normal boiling point of water at atmospheric pressure. For example, the alcohol can be ethanol. In particular, the non-aqueous solvent has a solubility ratio, defined as the ratio of solubility of the metal nitrate in water relative to the solubility of the metal nitrate in the non-aqueous solvent at a given temperature (e.g., the temperature of the solvent extraction), of at least 2, such as at least 3, or even at least 4.

As illustrated at 214, the solvent can be cycled until sufficient water is removed. In particular, dewatering, such as through solvent extraction, can be performed at a temperature not greater than 50° C., such as not greater than 35° C., or even not greater than 30° C.

The solvent and coated powder can be transferred to a collection tank, such as through pumping, as illustrated at 216. A rinse dryer or spray dryer can be used to remove the solvent, as illustrated at 218, and the coated powder can be further dried, such as vacuum dried or spray dried, as illustrated at 220, to remove the solvent.

Following drying, the coated particles can be further processed to prevent agglomeration, as illustrated at 222. For example, the coated particles can be mechanically treated to break agglomerates, such as through milling or crushing.

To form an oxide coating from the metal nitrate coating, the coated ceramic powder can be further heat treated, as illustrated at 224. In an example, the coated ceramic powder is heated to a temperature of at least 200° C., such as a temperature of at least 225° C., at least 250° C., at least 275° C., or even at least 300° C. or higher. For example, the coated ceramic powder can be flash dried. A cyclone can be used to collect the oxide coated powders, as illustrated at 226. Alternatively, a filter can be used.

The collected oxide coated ceramic powders can be transferred for further processing. In an example, the coated particles can be further processed to prevent agglomeration, such as through mechanically treatment to break agglomerates, for example, milling or crushing. In another example, coated ceramic powders can be used in an ink, coating, or polymer composite to form electronic components, such as dielectric components, for example, capacitive energy storage devices or capacitors.

In a particular example, the coated ceramic particles can have an average particle size (diameter) in a range of 0.5 micrometer to 5 micrometers, such as a range of 0.5 micrometers to 2 micrometers, or even a range of 0.7 micrometers to 1.5 micrometers. The oxide coating on the coated ceramic particles can have an average thickness in a range of 50 Å to 500 Å, such as a range of 50 Å to 200 Å, or even a range of 50 Å to 150 Å.

The examples described below assume that a 100 Å coating of aluminum oxide is desired in the finished product and are scaled for a batch size of 500 g. Upscaling is proportional to the amount of ceramic powder in the process. The relative permittivity (relative to air) of aluminum oxide is approximately 8.2 over the temperature range of −20° C. to 60° C. and a frequency range of 1 kHz to over 100 MHz. This low relative permittivity aluminum oxide layer of 100 Å reduces the overall relative permittivity of the dielectric layer by approximately 6%. Checking the relativity permittivity of the CMBT powders before coating and after coating provides an excellent quality control check on coating thickness.

Washing the powders with ethanol after coating removes the water from the powders to a level that when dried reduces the hard agglomeration of the powders. Drying the powders in a solvent solution of ethanol assists in allowing the powders to be readily broken up into fine particles for the final anti-agglomeration process of the flash drying unit.

Some aluminum nitrate is removed due to washing the coated powder in the ethanol solution. Additional aluminum nitrate coating thickness can be added to allow some nitrate removal during washing so that the final thickness is close to a 100 Å coating thickness. However, if less removal of the aluminum nitrate coating is required during the water removal step, the ethanol can be cooled to lower the solubility of the nitrate compound in the cooled ethanol.

In the examples below, each 1 μm diameter particle has a volume of approximately 5.24×10⁻¹³ cm³. The coating increases the diameter to 1.02 μm or a radius of 0.51 μm. The volume of the coated particle is approximately 5.557×10⁻¹³ cm³, resulting in a coating volume of 3.20×10⁻¹⁴ cm³ Aluminum oxide has a nominal density of 3.97 g/cm³, so the mass of coating for each particle is (3.97 g/cm³)·(3.20×10¹⁴ cm³)=1.27×10⁻¹³ g. In 500 g of CMBT, there are 500 g/(6.08 g/cm³)/(5.24×10⁻¹³ cm³)=1.57×10¹⁴ particles. Therefore, for 500 g of CMBT, 1.57×10¹⁴ particles·1.27×10⁻¹³ g aluminum oxide/particle=19.94 g of aluminum oxide are used. Each gram of aluminum oxide corresponds to 1 g Al₂O₃·(1 mol Al₂O₃/101.96 g Al₂O₃)·(2 mol Al/1 mol Al₂O₃)*(1 mol Al(NO₃)₃/1 mol Al)*(212.996 g Al(NO₃)₃/1 mol Al(NO₃)₃=4.178 g Al(NO₃)₃. Therefore, 19.94 g aluminum oxide is formed from 83.31 g aluminum nitrate. The solubility of aluminum nitrate is 40.8 g per 100 g solution at 25° C. and approximately 61.5 g per 100 g solution at 100° C. At 100° C., 1.60 g aluminum nitrate precipitates from solution for each gram of water removed from the system. To precipitate 83.31 g of aluminum nitrate at 100° C., 52 g of water is to be removed. The solubility of aluminum nitrate is 8.63 g per 100 g of solution of ethanol at 25° C.

### EXAMPLES

### Approach Number #1

Start with a room temperature saturated solution of aluminum nitrate. Add the desired amount of CMBT powder. Raise the temperature to near 100° C. and decrease the pressure around the solution, for example, using a vacuum pump to increase the rate of water evaporation. Once a sufficient amount of water has been removed, aluminum nitrate deposits on the CMBT powder. Filter or centrifuge the majority of the liquid off of the CMBT powder while the solution is hot. Transfer the wet powder to the water removal unit. Add ethanol to the processing tank and bubble mix the solution. Cycle the solution until sufficient water is removed from the powder. Pump the slurry into collection tank. Spray rinse the water removal unit to ensure the powders are transferred to the collection tank. Dry the powders. Break up soft agglomeration. Transfer the powder to the flash drying unit. Dry the powders in the flash dryer at a sufficient temperature and residence time to convert the aluminum nitrate to aluminum oxide. Collect the powder in a cyclone.

### Calculations of Water Evaporation:

52 g of water is to be removed once the solution is saturated.

To saturate the solution at 100° C. from a solution saturated at 25° C., 33.7 g of water is to be removed.

Total amount of water removed from the system is 85.7 g.

### Approach Number #2

Start with a room-temperature saturated solution of aluminum nitrate. Add the desired amount of CMBT powder. Raise the temperature to near 100° C. Add Al(NO₃)₃.9H₂O to bring the solution to saturation. Once a sufficient amount of water has been removed, aluminum nitrate deposits on the CMBT powder. Filter or centrifuge the majority of the liquid off of the CMBT powder while the solution is hot. Transfer the wet powder to the water removal unit. Add ethanol to the processing tank and bubble mix the solution. Cycle the solution until sufficient water is removed from the powder. Pump the slurry into the collection tank. Spray rinse the water removal unit to ensure the powder is transferred to the collection tank. Dry the powders. Break up the powders. Transfer the powder to the flash drying unit. Dry the powder in the flash dryer at a sufficient temperature and residence time to convert the aluminum nitrate to aluminum oxide. Collect the powder in a cyclone.

### Calculations of Water Evaporation:

52 g of water is to be removed once the solution is saturated.

To saturate the solution at 100° C. from a solution saturated at 25° C., 53.77 g of aluminum nitrate is added.

To add 53.77 g of aluminum nitrate, 94.6942 g aluminum nitrate nonahydrate is added.

### Approach Number #3

Start with a room-temperature saturated solution of aluminum nitrate. Add the desired amount of CMBT powder. Raise the temperature to near 100° C. and decrease external pressure (possibly full vacuum) to increase the rate of water evaporation. Once an amount of water has been removed, cool the solution. As the solution cools, aluminum nitrate deposits on the particles. Filter or centrifuge the majority of the liquid off of the CMBT powders. Transfer the wet powder to the water removal unit. Add ethanol to the processing tank and bubble mix the solution. Cycle the solution until sufficient water is removed from the powder. Pump the slurry into the collection tank. Spray rinse the water removal unit to ensure the powder is transferred to the collection tank. Dry the powder. Break up the powder. Transfer the powder to the flash drying unit. Dry the powder in the flash dryer at a sufficient temperature and residence time to convert the aluminum nitrate to aluminum oxide. Collect the powder in a cyclone.

### Calculations of Water Evaporation:

To deposit 83.31 g of aluminum nitrate at 25° C., 120.8 g of water is removed.

The technique used in the example below is Approach #3, which does not utilize heating the centrifuge to a temperature of approximately 100° C., so that additional Al(NO₃)₃ does not precipitate out of solution. Such a technique can also apply to other metal nitrates for coating ceramic powders. Also, different temperatures, amounts of nitrates used for coating different film thickness, dewatering techniques, or powder collection techniques can be used depending on the applications.

The exemplary coating process is based on precipitation from a supersaturated solution of aluminum nitrate. Few contaminants contained in the initial solution of aluminum nitrate, e.g., sodium and potassium, deposit with the coating, providing assistance in purifying the final aluminum oxide coating.

### Example 1

A purified aluminum nitrate solution is analyzed on a Perkin Elmer Optima 2100DV ICP-OES. Two calibration curves are generated for both sodium and potassium; one for low concentrations (0.0500 ppm to 0.500 ppm) and one for high concentrations (0.500 ppm to 7.50 ppm). The standards used are based on stock solutions from High Purity Standards, Inc. and the resulting calibration curves have correlation coefficients greater than 0.998. Dilutions are made using 18 megaohm deionized water with no detectable metals.

The solution of Al(NO₃)₃ contains a concentration of sodium of 0.492 ppm and 0.367 ppm potassium. After the coating process the Al(NO₃)₃ coating is washed off with DI water and extreme care is taken to ensure that no sodium or potassium is added to the final test solution. The concentration of the sodium and potassium can be in the parts-per-trillion (ppt) range, indicating that during the coating process sodium and potassium are rejected.

In a technique for detecting the thickness of the aluminum oxide films, samples are tested for a change in relative permittivity. For example, a sample of the aluminum nitrate coated powder, after drying, is taken and measured. The weight of the sample is 59.12 grams. The particles are washed with DI water to remove the aluminum nitrate film and dried. The weight of the dried powder is 50.7 g. The weight of the removed aluminum nitrate is 8.42 g, close to the total weight of 58.031 g to obtain the 100 Å aluminum oxide film. Also, the drop in the relative permittivity of the CMBT powder is 6.15%, which also indicates a film thickness close to the 100 Å of thickness.

In a further example, specified amounts of CMBT powder, aluminum nitrate, and DI water are added to the ultrasonic tank. The ultrasonic tank is activated and heated to the specified temperature. The vacuum pump is activated and a specified amount of water is evaporated. The ultrasonic tank is cooled to approximately 25° C. The solution is transferred to the centrifuge and the powder is dewatered. The wet powder is transferred to the water removal unit.

The powder is transferred to a flash drier, which converts the aluminum nitrate to aluminum oxide. The high velocity air from the flash drier transfers the coated CMBT powder to the cyclone where the powder is sorted and the high velocity air exits the top of the cyclone and the powder falls to the bottom of cyclone. The high velocity transfer of the powder assists in removing agglomeration from the powder. The powder is transferred to the next processing step, such as incorporation into an ink, polymer composite, or slurry.

In an aspect, a method of forming an oxide coated dielectric powder includes mixing ceramic particles and an aluminum nitrate aqueous solution, depositing aluminum nitrate on the surface of the ceramic particles to form coated ceramic particles, separating the coated ceramic particles, dewatering the coated ceramic particles, and heat treating the coated ceramic particles under conditions sufficient to convert the deposited aluminum nitrate to aluminum oxide, forming oxide coated ceramic particles. In an example of the aspect, the deposited aluminum nitrate is aluminum nitrate nona-hydrate.

In an example of the aspect, depositing aluminum nitrate includes evaporating water from the aluminum nitrate aqueous solution to precipitate aluminum nitrate on the surface of the ceramic particles. For example, evaporating water can include heating the aluminum nitrate aqueous solution to at least a boiling point of the aluminum nitrate aqueous solution. In another example, evaporating water includes reducing a pressure associated with the aluminum nitrate aqueous solution.

In another example of the aspect, depositing aluminum nitrate includes cooling the aluminum nitrate aqueous solution to precipitate aluminum nitrate on the surface of the ceramic particles. For example, depositing aluminum nitrate further can include elevating the temperature of the aluminum nitrate aqueous solution and concentrating the aluminum nitrate aqueous solution prior to cooling the aluminum nitrate aqueous solution. In an example, elevating the temperature includes increasing the temperature to at least within 5° C. of a boiling point of the aluminum nitrate aqueous solution. In another example, cooling the aluminum nitrate aqueous solution includes cooling by at least 25° C., such as by at least 40° C., by at least 60° C., or even by at least 70° C. In an additional example, cooling the aluminum nitrate aqueous solution includes cooling to a temperature not greater than 35° C., such as not greater than 30° C., or even not greater than 28° C.

In a further example of the aspect, the ceramic particles include composition-modified barium titanate particles. In an additional example of the aspect, separating the coated ceramic particles includes filtering, centrifuging, or a combination thereof. For example, centrifuging can include injecting the aluminum nitrate aqueous solution and the coated ceramic particles into a cyclone centrifuge.

In another example of the aspect, dewatering includes washing the coated ceramic particles with a non-aqueous solvent. For example, the non-aqueous solvent is an alcohol, ketone, glycol, or a combination thereof. In an example, the alcohol has a normal boiling point not greater than a normal boiling point of water. For example, the alcohol can include ethanol. In another example, the non-aqueous solvent has a solubility ratio of at least 2, such as at least 3, or even at least 4. In an additional example, dewatering is performed at a temperature not greater than 50° C., such as not greater than 35° C., or not greater than 30° C. In a particular example, the method further includes drying coated ceramic particles to remove the non-aqueous solvent. For example, drying can include vacuum drying.

In a further example of the aspect, heat treating includes heat treating at a temperature of at least 250° C. For example, heat treating can be performed in a flash dryer.

In an additional example of the aspect, the method further includes mechanically breaking agglomerates. Mechanically breaking can be performed after dewatering. In a further example, mechanically breaking can be performed after heat treating.

In another example of the aspect, the ceramic particles have an average particle size in a range of 0.5 micrometers to 5 micrometers, such as a range of 0.5 micrometers to 2 micrometers, or a range of 0.7 micrometers to 1.5 micrometers.

In a further example of the aspect, the oxide coated ceramic particles have an average coating thickness in a range of 50 Å to 500 Å, such as a range of 50 Å to 200 Å, or a range of 50 Å to 150 Å.

In another aspect, a method of forming an oxide coated dielectric powder includes mixing composition-modified barium titanate particles and an aluminum nitrate aqueous solution, depositing aluminum nitrate on the surface of the composition-modified barium titanate particles to form coated composition-modified barium titanate particles, separating the coated composition-modified barium titanate particles, dewatering the coated composition modified barium titanate particles, and heat treating the coated composition-modified barium titanate particles under conditions sufficient to convert the deposited aluminum nitrate to aluminum oxide, forming oxide coated composition-modified barium titanate particles. In an example of the aspect, the deposited aluminum nitrate is aluminum nitrate nona-hydrate.

In an additional aspect, a method of forming a dielectric powder includes depositing a metal nitrate coating on ceramic particles to form nitrate coated ceramic particles, separating the nitrate coated ceramic particles, dewatering the nitrate coated ceramic particles, and heat treating the nitrate coated ceramic particles at a temperature sufficient to convert the metal nitrate to a metal oxide, forming metal oxide coated ceramic particles. In an example of the aspect, the deposited metal nitrate is aluminum nitrate.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A method of forming an oxide coated dielectric powder, the method comprising:
mixing ceramic particles and an aluminum nitrate aqueous solution;
depositing aluminum nitrate on the surface of the ceramic particles to form coated ceramic particles;
separating the coated ceramic particles;
dewatering the coated ceramic particles; and
heat treating the coated ceramic particles under conditions sufficient to convert the deposited aluminum nitrate to aluminum oxide, forming oxide coated ceramic particles.

2. The method of claim 1, wherein the deposited aluminum nitrate is aluminum nitrate nona-hydrate.

3. The method of claim 1, wherein depositing aluminum nitrate includes evaporating water from the aluminum nitrate aqueous solution to precipitate aluminum nitrate on the surface of the ceramic particles.

4. The method of claim 3, wherein evaporating water includes heating the aluminum nitrate aqueous solution to at least a boiling point of the aluminum nitrate aqueous solution.

5. The method of claim 3, wherein evaporating water includes reducing a pressure associated with the aluminum nitrate aqueous solution.

6. The method of claim 1, wherein depositing aluminum nitrate includes cooling the aluminum nitrate aqueous solution to precipitate aluminum nitrate on the surface of the ceramic particles.

7. The method of claim 6, wherein depositing aluminum nitrate further includes elevating the temperature of the aluminum nitrate aqueous solution and concentrating the aluminum nitrate aqueous solution prior to cooling the aluminum nitrate aqueous solution.

8. (canceled)

9. The method of claim Error! Reference source not found, wherein cooling the aluminum nitrate aqueous solution includes cooling by at least 25° C.

10.-12. (canceled)

13. The method of claim 6, wherein cooling the aluminum nitrate aqueous solution includes cooling to a temperature not greater than 35° C.

1.-15. (canceled)

16. The method of claim 1, wherein the ceramic particles include composition-modified barium titanate particles.

17. The method of claim 1, wherein separating the coated ceramic particles includes filtering, centrifuging, or a combination thereof.

18. The method of claim 17, wherein centrifuging includes injecting the aluminum nitrate aqueous solution and the coated ceramic particles into a cyclone centrifuge.

19. The method of claim 1, wherein dewatering includes washing the coated ceramic particles with a non-aqueous solvent.

20.-22. (canceled)

23. The method of claim 19, wherein the non-aqueous solvent has a solubility ratio of at least 2.

2.-25. (canceled)

26. The method of claim 1, wherein dewatering is performed at a temperature not greater than 50° C.

3.-32. (canceled)

33. The method of claim 1, further comprising mechanically breaking agglomerates.

34.-35. (canceled)

36. The method of claim 1, wherein the ceramic particles have an average particle size in a range of 0.5 micrometers to 5 micrometers.

37.-38. (canceled)

39. The method of claim 1, wherein the oxide coated ceramic particles have an average coating thickness in a range of 50 Å to 500 Å.

40.-43. (canceled)

44. A method of forming a dielectric powder, the method comprising:
depositing a metal nitrate coating on ceramic particles to form nitrate coated ceramic particles;
separating the nitrate coated ceramic particles;
dewatering the nitrate coated ceramic particles; and
heat treating the nitrate coated ceramic particles at a temperature sufficient to convert the metal nitrate to a metal oxide, forming metal oxide coated ceramic particles.

45. The method of claim 44, wherein the deposited metal nitrate is aluminum nitrate.
